(19) United States
(12) Patent Application Publication
(10) Pub. No.: US 2014/0278826 A1
(43) Pub. Date: Sep. 18, 2014

(54) Enhanced Human Capital Management System and Method

(71) Applicant: ADP, Inc., Roseland, NJ (US)

(72) Inventors: Thomas Miller, Pompton Plains, NJ (US); Rich Wilson, Randolph, NJ (US); Marc Rind, Summit, NJ (US)

(73) Assignee: ADP, Inc., Roseland, NJ (US)

(21) Appl. No.: 13/840,079

(22) Filed: Mar. 15, 2013

(51) Int. Cl. G06Q 10/06

(52) U.S. Cl. CPC G06Q 10/06398
USPC 705/7.39; 705/7.42

(57) ABSTRACT

A system and method for human capital management. A set or sets of records corresponding to employees are encoded on a digital storage medium. Each record contains values for human capital management metrics. A user device accesses these records and presents on a display a dashboard management window. The dashboard management window contains at least one dashboard, which has at least one automatically-generated representation of the human capital metric values stored in the records encoded on the digital storage medium. The dashboards and their representations allow a user to effectively and efficiently manage human capital by easily viewing human capital metrics in a meaningful way.

### FIELD OF THE DISCLOSURE

The subject matter of the present disclosure generally relates to human capital management, and more particularly relates to an easy-to-use and effective capital management system having a user interface with which to assess and manage human capital.

### BACKGROUND OF THE DISCLOSURE

Electronic systems for managing human capital have been previously disclosed. Users of such systems are often still required to manually manipulate employee data into useable formats, such as charts or other visual representations. When users need to view data as organized by an alternate criteria, such as viewing headcount as organized by age group instead of by geographical location, they are often hindered by the need to produce entirely new representations with a time consuming process. Previously disclosed systems also often require users to navigate extensive menus to locate needed information. Often such information is not collated into a single view, so users must consistently transfer between views or screens to attempt to assemble information in a meaningful fashion. Together these difficulties can prevent users from gaining the overall and fluid perspective of human capital that is necessary to excel in dynamic business environments.

Human resource departments are expensive to maintain and often it is difficult for companies to justify the expenditure of additional funds for additional human resource personnel. This reality leads to overburdened human resource departments that are impeded in performing, or assisting management in performing, human capital management functions. For small businesses, it can be prohibitively expensive to maintain even a single dedicated human resource officer, meaning that another employee must perform the functions of such an officer, often without training or experience. Management personnel can find previously disclosed systems cumbersome and overly time consuming to use extensively. Thus, opportunities to adjust human capital management strategies are missed and management must make important human capital decisions without sufficient information. For instance, it can be difficult for management to effectively craft a plan of succession that ensures needed human capital is available without overpaying for this security. Such impairments and inefficiencies can negatively impact company operations and profit.

An easy-to-use interface that allows users to quickly view multiple human capital metrics simultaneously and quickly readjust that view to reflect human capital management needs is therefore desirable.

The subject matter of the present disclosure is directed to overcoming, or at least reducing the effects of, one or more of the problems set forth above.

### BRIEF SUMMARY OF THE DISCLOSURE

Disclosed is a system and method for human capital management (HCM). A user with an electronic device is presented an interface with dashboards that contain automatically-generated representations of human capital metric values for various employees. Human capital metric values for employees are stored in records encoded on a digital storage medium, such as a hard drive. In an exemplary embodiment of the disclosed subject matter, a user accesses HCM information and is presented HCM dashboards on the web browser of an Internet-connected tablet computer that retrieves HCM information from a remote digital storage medium through the Internet.

The HCM dashboards can optionally contain graphical representations, such as graphs or charts, that assist in user comprehension of data and data trends. In an exemplary embodiment, users are able to view specific dashboards in enlarged windows with additional details and create custom dashboards for unique needs.

Users can easily and quickly view human capital management metrics in a variety of different formats according to a variety of criteria without being restrained by the need for manual data manipulation. Optionally, users can perform additional useful functions, such as sharing their dashboard views with others and making comments on dashboards so that human capital management becomes a truly collective exercise.

Human capital metrics can be numerous Key Performance Indicators (KPIs) that have established definitions and criteria designed to provide maximum information value to the user. The use of KPIs can help users drive to the answers to their human capital management questions. Human resource personnel costs can be reduced while human capital management is simultaneously more effective.

The details of one or more embodiments of the invention are set forth in the accompanying drawings and descriptions below. The foregoing summary is not intended to summarize each potential embodiment or every aspect of the disclosure.

### BRIEF DESCRIPTION OF THE DRAWINGS

The foregoing summary, preferred embodiments, and other aspects of subject matter of the present disclosure will be best understood with reference to a detailed description of specific embodiments, which follows, when read in conjunction with the accompanying drawings, in which:

FIG. 1 is a diagram of an exemplary embodiment of the disclosed system in which an electronic user device is connected to a remote digital storage medium.

FIG. 2 is a diagram of an exemplary embodiment of the disclosed system in which an electronic user device has a local digital storage medium.

FIG. 3 is an illustrative depiction of an exemplary embodiment in which employee records with human capital metric values are visualized.

FIG. 4 is a diagram of an exemplary embodiment of the disclosed system in which an electronic user device has a local digital storage medium.

FIG. 5 is an illustration of an exemplary embodiment including an analytics window contained within a general user interface accessed in a web browser.

FIG. 6 is an illustration of the embodiment of FIG. 5 in which the user is presented with a user interface through an application local to the user's device.

FIG. 7 is an illustration of an exemplary embodiment in which the user is presented a dashboard management window having multiple dashboards.

FIG. 8 is an illustration of the embodiment of FIG. 7 in which the view of a particular dashboard is expanded.

FIG. 9 is illustration of the embodiment of FIG. 7 in which the dashboard management window has two rows of dashboards.

FIG. 10 is an illustration of an exemplary embodiment in which a dashboard management window is displayed in a landscape view with two columns of dashboards.

FIG. 11 is an illustration of the embodiment of FIG. 10 in which the view of a particular dashboard is expanded.

FIG. 12 is an illustration of the embodiment of FIG. 10 in which the views of two particular dashboards are expanded.

FIG. 13 is an illustration of the embodiment of FIG. 7 in which a detailed dashboard window is presented.

FIG. 14 is an illustration of the embodiment of FIG. 13 in which a different view of a human capital metric is presented.

FIG. 15 is an illustration of the embodiment of FIG. 7 in which the functionality of an export button is demonstrated.

FIG. 16 is an illustration of the embodiment of FIG. 7 in which the functionality of an search query box is demonstrated.

FIG. 17 is an illustration of the embodiment of FIG. 7 in which a window is presented for the creation of a custom dashboard.

FIG. 18 is an illustration of the embodiment of FIG. 7 in which the functionality of a share button is demonstrated.

FIG. 19 is an illustration of the embodiment of FIG. 7 in which the functionality of a comment button is demonstrated.

FIG. 20 is an illustration of the embodiment of FIG. 7 in which the functionality of an information icon is demonstrated.

FIG. 21 is an illustration of the embodiment of FIG. 7 in which the functionality of a slider bar is demonstrated.

FIG. 22 is an illustration of the embodiment of FIG. 7 in which a detailed view of the Employee Headcount KPI is presented.

FIG. 23 is an illustration of the embodiment of FIG. 7 in which a detailed view of the Temp Employee Percentage KPI is presented.

FIG. 24 is an illustration of the embodiment of FIG. 7 in which a detailed view of the Part-Time Percentage KPI is presented.

FIG. 25 is a diagram of an exemplary embodiment of the disclosed system in which an electronic user device has a local digital storage medium.

FIG. 26 is an illustration of the embodiment of FIG. 7 in which a detailed view of the Inactive Status Ratio KPI is presented.

FIG. 27 is an illustration of the embodiment of FIG. 7 in which a detailed view of the Leave Rate KPI is presented.

FIG. 28 is an illustration of the embodiment of FIG. 7 in which a detailed view of the Average Age KPI is presented.

Like reference numbers and designations in the various drawings indicated like elements.

### DETAILED DESCRIPTION OF THE DISCLOSURE

Disclosed is a system and method of human capital management (HCM). HCM value data is encoded on a digital storage medium, which is accessed, manipulated, and presented to a user or users on an electronic device. Where described below, virtual “buttons,” drop-down menus, icons and similar items are understood to be elements presented on the display of an electronic device and “selectable” or capable of being manipulated by user input to a the electronic device. Input by a user is understood to encompass a wide variety of circumstances, such as text entry via a keyboard, selection of a virtual object via a computer mouse, or interaction with a touch-sensitive screen.

FIG. 1 is a diagram an exemplary embodiment in which a user electronic device is connected to a remote digital storage medium. User device 101 has processor 102 and display 103. Processor 102 accesses records on digital storage medium 104, which is located within server 105, by communicating with processor 106 through network 107. Optionally, network 107 is the Internet. The remote storage of records can be advantageous. For instance, the remote storage of records eliminates the need to store information directly on the user electronic device, providing increased security. If the user device is lost, no sensitive employee information is compromised. Also, the use of “cloud” storage can allow multiple users to access and modify records simultaneously or allow the automatic syncing of records and dashboards. FIG. 2 is a diagram of an exemplary embodiment in which a user electronic device has a local digital storage medium. User device 201 has processor 202 and local digital storage medium 203 and display 204.

FIG. 3 is an illustrative depiction of an embodiment of the disclosed subject matter in which mobile user device 301 and stationary user device 302 interact with remote server 303 through network 304. Server 303 has processor 305 and digital storage medium 306. First record set 307 and second record set 308, which are encoded on digital storage medium 306, are visualized for demonstrative purposes. First record set 307 has a plurality of records, each record associated with an individual employee, for instance first employee record 309. Likewise, second record set 308 has a plurality of records, each associated with an individual employee, for instance fourth employee record 310. First employee record has human capital metric 311 and an associated value 312. Fourth employee record 309 also has human capital metric 310 but an associated value 313. User devices 301 and 302 are effective to access digital storage medium 305 and record sets 306 and 307, retrieve human capital metric values 311 and 312, and display to a user representations of this data.

Employee records and human capital metric values can be stored in any number of suitable fashions. Employee records need not be individual files. FIG. 4 is a demonstrative illustration of records as stored in a single file in an array fashion. Record set 401 is encoded on digital storage medium 402. First employee record 403 and second employee record 404 are stored in array 405. Each employee record has associated human capital metrics values.

FIG. 5-28 are illustrations of an exemplary embodiment of the disclosure, and it is understood that their content does not limit the scope of the disclosed subject matter or claims.

FIG. 5 is an illustration of an exemplary embodiment in which display 501 of mobile user device 502 presents to a user a user interface. In the embodiment, user device 502 is a tablet computer having a touch sensitive screen capable of receiving user input. Display 501 depicts a general HCM interface, in which analytics window 503 has dashboards 504, each of which has a representation 505 of the human capital metric values associated with a plurality of employee records. Dashboard button 506 allows the user to access a dashboard management window. Navigation buttons 507 allow a user to scroll through analytics window 503 to view various dashboards. In the embodiment, the disclosure is accessed through web browser 508. Allowing users to access the disclosed interface through a web browser can be advantageous. In doing so the interface can be automatically updated without the need for the user to download, install or troubleshoot software patches. Also, the user can access the interface platform from any suitable electronic device connected to the network through which the digital storage medium is accessible. FIG. 6 is an illustration of an exemplary embodiment in which the disclosed interface is presented on a display using an application native to device 502. Operating the disclosed interface through a native application can be advantageous. For instance, this may allow better interface performance and response to user input.

FIG. 7 is an illustration of an exemplary embodiment in which an interface is presented on display 501 of user device 502. Dashboard management window 701 includes plurality of dashboards 702. Particular dashboard 703 has numerical representation 704 which is automatically generated from the human capital metric values of a plurality of employee records. Automatic generation means without the need for manual creation by the user. For instance, dashboard 703 also has graphical representation 705 which is also automatically generated from the human capital metric values of a plurality of employee records and presented in the dashboard. Delete icon 706 is selectable by the user and when selected causes dashboard 703 to be deleted from dashboard management window 701. Expand icon 707 is selectable by the user and when selected causes display 501 to present an expanded view of dashboard 703. FIG. 8 illustrates dashboard 703 as expanded after the selection of expand icon 707. Additional content 801 is displayed. Details icon 802 allows the user to view an expanded window regarding the human capital metric of dashboard 703. Contract icon 803 replaces expand icon 707 when dashboard 703 is expanded, allowing the user to return dashboard 703 to a contracted form.

FIG. 9 illustrates dashboard management window 701 in an alternate setup in which two rows of dashboards are presented. In the embodiment, only numerical representations are displayed on each dashboard to accommodate the screen size and orientation of display 501 of user device 502.

FIG. 10 illustrates dashboard management window 701 as presented on display 1001 of user device 1002 in which the interface is viewed in a landscape fashion. Dashboards 702 are displayed with both a numerical and graphical representation of human capital metric values from employee records.

FIG. 11 illustrates dashboard 703 expanded while the interface is viewed in landscape fashion. FIG. 12 illustrates dashboard 703 and dashboard 1201 simultaneously expanded while the interface is viewed in landscape fashion.

FIG. 13 illustrates an enlarged view of a dashboard in detail window 1301. Detail window 1301 contains additional HCM functionality. View selection box 1302 allows the user to select to view the dashboard representations and information as organized according to a variety of criteria. For instance, headcount could be viewed by location or age. Each view type allows the user to view the human capital metric values in a different light. New representations are presented on display 501 when a different view type is selected by the user. Optionally, view selection box is a drop down menu box. Filter/threshold selection button 1303 allows the user to apply a filter to the human capital metric value data from which the representation of the corresponding dashboard is created. For instance, for a multi-national corporation, a user could select to only view headcount for company locations in the United States. Filter/Threshold selection button also allows a user to set thresholds associated with a human capital metric. For instance, a user could set a 2 percent threshold for overtime hours during a month. If more than 2 percent of employee hours during the given month were overtime hours, an alert would be generated for the user. Save button 1304 allows a user to capture the choices described in relation to FIG. 13. For instance, save button 1304 will store a filter, threshold or view setting as input by the user.

FIG. 14 illustrates detail window 1301 of FIG. 13 with the headcount human capital metric viewed by status instead of by location. Graphical representation 1401 is a pie graph of human capital metric values. Detailed information output 1402 is displayed below graphical representation 1401 to provide the user with a more detailed understand.

FIG. 15 illustrates further functionality of detail window 1301 as presented on user device 502. Export drop down button 1501, when selected by user input, presents various options on drop down option menu 1502 which allows the user to digitally “export” the information contained in detail window 1301. For instance, selecting the “PDF” option will allow the user to export the information of detail window 1301 into a PDF format document.

FIG. 16 illustrates the functionality of dashboard search box 1601. When a user enters a query term and executes a search, the user is presented with available dashboards related to the query term in search return box 1602. In the example, three dashboards related to the query term “time” are found. Similar information to that presented on dashboards on dashboard management window 701 is presented next to each returned dashboard option in search return box 1602. This can assist the user in quickly determining whether a particular dashboard provides the information that the user is seeking Dashboard addition button 1603 allows the user to add the particular selected dashboard to dashboard management window 701. Detailed preview button 1604 allows the user to view additional details about the particular dashboard so that the user can determine with greater specificity whether that particular dashboard provides the information that the user is seeking.

FIG. 17 illustrates an exemplary embodiment in which user device 502 presents custom dashboard design window 1701 on display 501. Custom dashboard design window 1701 allows a user to create a dashboard designed for a custom purpose. The user can select a human capital metric with human capital metric drop down menu 1702 and a benchmark by which to evaluate that metric with benchmark drop down menu 1703. The user can also set a threshold for the custom dashboard with threshold entry box 1704.

FIG. 18 illustrates an exemplary embodiment having the functionality of share button 1801. When share button 1801 is selected by the user, share drop down window 1802 is presented. Share drop down window 1802 allows the user to share their view of dashboard management window 701 with other individuals. FIG. 19 illustrates an exemplary embodiment having the functionality of comment button 1901. When comment button 1901 is selected by the user, comment drop down window 1902 is presented. Comment drop down window 1902 allows a user to comment on a particular dashboard management window, either privately or as shared with other individuals. Comments from users are collected in comment drop down window 1902. Enabling users to share and comment on dashboard management windows helps to make HCM a collaborative process.

FIG. 20 illustrates an exemplary embodiment having the functionality of information icon 2001. When information icon 2001 is selected by the user, drop down information window 2002 is presented to the user. Optionally, information icon 2001 can be activated by the user by scrolling to and holding a cursor over information icon 2001. On a touch screen, information icon 2001 can be operated by the user touching information icon 2001. Drop down information window 2002 provides the user with an overview of the purpose and function of the particular dashboard. Additional information icon 2003, when selected, presents the user with more detailed information about the particular dashboard.

FIG. 21 illustrates an exemplary embodiment having the functionality of slider bar 2101. Slider bar 2101 presents to the user a set of summary information icons 2102. Summary information icons 2102 provide quick-reference, select information about a particular human capital metric. Selection of a summary information icon will cause additional information about that human capital metric to be presented to the user. Scroll icons 2103 allow the user to scroll through available summary information icons 2102.

FIG. 22 illustrates an exemplary embodiment having the functionality of alerts pop-up window 2201. Alerts pop-up window 2201 presents alerts the user when a particular criteria is met within the set of records or when opened by the user. For instance, if the total number of employee hours for a month exceeds a threshold criteria, the user is alerted so that the user can take appropriate action.

Disclosed below are a number of optional, exemplary KPIs which can be utilized with the disclosed subject matter. These KPIs assist in HCM by providing important relevant information to a user.

The Employee Headcount KPI represents the total count of employees. In an exemplary embodiment, the employee headcount KPI is presented in numerical form for the current quarter with a trend line chart demonstrating a 5 quarter trend. This KPI can be analyzed with any human resource dimension, such as diversity, tenure, performance or age. The Employee Headcount KPI serves several business objectives. It assists in measuring the growth or reduction of an organization's overall workforce over time. It is an indirect indicator of productivity and operational costs. It also helps quantify population shifts and predict potential drivers of fluctuation in specific segments of workforce population. FIG. 23 illustrates the Employee Headcount KPI as presented to a user on display 501 of user device 502.

The Temp Employee Percentage KPI represents the ratio of temporary and permanent employees in percentile fashion. In an exemplary embodiment, the Temp Employee Percentage KPI is presented in numerical percent form for the current quarter with a trend line chart demonstrating a 5 quarter trend. The Temp Employee Percentage KPI serves several business objectives. When analyzed with tenure, job groups, and performance it can provide insight into the most effective proportion of part time workers and can justify of the conversion of temporary employees into permanent employees. FIG. 24 illustrates the Temp Employee Percentage KPI as presented to a user on display 501 of user device 502.

The Part-Time Percentage KPI represents the percentage of active part-time employees. In an exemplary embodiment, the Part-Time Percentage KPI is presented in numerical percent form for the current quarter with a trend line chart demonstrating a 5 quarter trend. The Part-Time Percentage KPI serves several business objectives. It can be an indirect indicator of the optimal operation cost and flexibility of an organization. When used with a time measure, this analytic can be useful for complying with workforce benefits regulations. It can also be used to help evaluate and predict shifts in workforce flexibility. FIG. 25 illustrates the Part-Time Percentage KPI as presented to a user on display 501 of user device 502.

The Inactive Employee Ratio KPI represents the count of employees with a particular status (such as suspended, unpaid leave, paid lead). In an exemplary embodiment, the Inactive Employee Ratio KPI is presented in numerical percent form for the current quarter with a trend line chart demonstrating a 5 quarter trend. The Inactive Employee Ratio serves several business objectives. It can assist a user in finding the root cause of a lack of productivity. It can also assist in the planning the acquisition of temporary resources where such resources may be necessary. It can also assist a user in identifying and correcting unusual trends of inactive employees. FIG. 26 illustrates the Inactive Employee Ratio KPI as presented to a user on display 501 of user device 502.

The Leave Rate KPI represents the count of employees having taken leave during a particular period of time. In exemplary embodiment, the Leave Rate KPI is presented in numeral form per thousand employees with a trend line chart demonstrating a 5 quarter trend.

The Leave Rate KPI serves several business objectives. It can assist a user in planning the acquisition of temporary resources where necessary due to employee unavailability. It can also assist a user in identifying and correcting unusual trends of paid or unpaid leave. FIG. 27 illustrates the Leave Rate KPI as presented to a user on display 501 of user device 502.

The Average Age KPI represents the average age of employees at the end of a given period. In an exemplary embodiment, the Average Age KPI is presented in numerical form with a trend line chart demonstrating a 4 year trend. The Average Age KPI serves several business objectives. It can assist a user in identifying areas of increased risk and opportunity for training and knowledge transfer at an organization. It can also assist in ensuring the age distribution in each job classification that is optimum and effective. FIG. 28 illustrates the Average Age KPI as presented to a user on display 501 of user device 502.

The Age Groups KPI represents the percentage of active employees in each age group. The Age Groups KPI serves several business objectives. It can assist in identifying areas of increased risk in succession planning and the transfer of knowledge at an organization. It can also assist in ensuring that the age distribution in each job classification is optimum and effective.

The Generation Ratio KPI represents the percentage of active employees in each generation band, for example Generation X. The Generation Ratio KPI serves several business objectives. It can assist in identifying areas of increased risk in succession planning and the transfer of knowledge at an organization. It can also assist in ensuring that the age distribution in each job classification is optimum and effective.

The Average Employee Tenure KPI represents the average tenure of employees as calculated between the date of hire and the current date. In an exemplary embodiment the Average Employee Tenure KPI is presented in numerical fashion in years with a line chart for the last 4 years. The Average Employee KPI serves several business objectives. It can be an indirect indicator of workforce value potential, performance and engagement. It can also be used as a predictor of key segments of the population that have higher overall levels of experience and value.

The Average Position Tenure KPI represents the average tenure of job positions as calculated between date of hire and the current date. The Average Position Tenure KPI serves several business objectives. It can indicates over-all position specific experience in an organization. It can serve as an indirect indicator of workforce value potential, performance and engagement and assist in identifying risks from inexperience. It can also be used to identify potential opportunities for internal mobility.

The Tenure Range Ratio KPI represents the percentage of employees in each tenure range. The Tenure Range Ratio KPI serves several business objectives. It can serve as an indirect indicator of workforce value, performance and engagement. It can also be used as a predictor for key segments of the employee base that have higher overall levels of experience and value at an organization.

The Ethnicity Ratio KPI represents the percentage of active employees in each defined ethnic group. Optionally, it can use the definition of minorities of the United States census bureau. Unspecified individuals can either be included or excluded. The Ethnicity Ratio KPI serves several business objectives. It can assist in identifying pockets of a workforce that are significantly different and in need of investigation. It can also assist in measuring shifts in distribution of the workforce by ethnicity group.

The Gender Ratio represents the female to male ratio as a percentile ratio. This KPI serves several business objectives, and can help identify pockets of a workforce that are significantly different and in need of investigation.

The Average Retirement Age KPI represents the average age of employees in years who have departed the organization due to retirement in the last 5 years. This KPI serves several business objectives. When applied to job groups or organization units it can measure assist in succession planning It can also assist in identifying unusual trends and thus the cause of employees leaving the company earlier than the otherwise expected retirement age.

The Retirement Eligibility KPI represents the count of employees who has reached retirement age (67) who are still active. This KPI serves several business objectives. When analyzed in respect to job group or organization unit, it can enable proactive planning and assist in the identification of critical roles that are blocking needed succession for unusually long periods.

The Projected Retirement KPI represents the total number of employees, expressed as a percentage of total employees, who will reach retirement age (67) in the next 5 years. This KPI can analyzed in respect to job group or organization unit to enable proactive workforce and succession planning.

The Total Turnover KPI represents the count of terminations and transfers divided by the number of employees, in percentile. This KPI serves several business objectives. It can assist in identifying and retaining desired individuals, helping to avoid the costs and disruption associated with turnover. It can also assist in identifying any alarming trends for employees separating from a particular segment of a company faster than expected.

The Voluntary Termination KPI represents the count of voluntary terminations for a time period expressed as a percentage of the total of active employees. This KPI serves several business advantages. It enables organizations to proactively address the costs and disruptions associated with turnover, identify alarming trends of higher-than-usual voluntary termination, retain desired talent and evaluate retention efforts.

The Involuntary Termination KPI represents the count of involuntary terminations for a time period expressed as a percentage of active employees. This KPI serves several business advantages. It can assist in ensuring involuntary terminations are aligned with company strategy, assessing high performer retention and can serve as an indirect indicator of ineffective recruiting or work environment.

The New Hire Termination KPI represents the count of terminations of employees with a tenure of less than 1 year. This KPI serves several business objectives. It can serve as an indicator of the effectiveness of hiring practices and help avoid rehiring costs.

The Internal Mobility KPI represents the sum of transfers and promotions expressed as a percentage of average employee headcount. This KPI serves several business objectives. It can serve as an indirect indicator of a potential lack of succession depth or talent pipeline. It can help assess whether external hiring costs are being reduced through internal mobility. Generally, this KPI can help more effectively plan position filling.

The Transfer Rate KPI represents the total number of employee transfers expressed as a percentage of average employee headcount. This KPI serves several business objectives. It can serve as a measure of internal mobility and identify opportunities for career building as well as knowledge and skills growth. When analyzed with tenure, it can serve as an indirect indicator of poor hiring decisions as reflected in employee transfers. It can also indicate improved capabilities and skill sets, reduced turnover, increased employee engagement and reduced total workforce cost.

The Promotion Rate KPI represents the total number of promotions awarded, expressed as a percentage of average employee headcount. This KPI serves several business objectives. It can serve as a measure of opportunities for internal advancement, help predict increased retention of high performance employees, workforce tenure and high overall employee engagement. It can also assist in predicting the increased costs of salary increases.

The Internal Mobility Hire Ratio KPI represents the percentage of transfers divided by transfers and external hires. This KPI can help measure the relative importance that an organization places on internal mobility versus external talent acquisition. It can also serve as an indirect indicator of a potential lack of succession depth, talent pipeline or the organization's focus on filling positions internally.

The Manager Span of Control KPI represents the total population as divided by the total management population. This KPI can be used to measure the overall productivity and efficiency of an organization and evaluate whether management is top heavy or stretched too thin.

The Total Earnings KPI represents the sum of total earnings. This KPI can serve as an indicator of employee costs, an indirect indicator of the relative competitiveness of an organization, or when combined with other metrics a measure of productivity.

Earning Code Totals KPI represents the total earnings per earning code. The Earnings Code Averages KPI represents the total earnings per earning code divided by the number of employees.

Total Overtime Cost KPI represents the total costs associated with overtime. It can be used to evaluate the effectiveness of part-time employees and predict shifts in workforce flexibility. The Average Overtime Cost KPI represents the total costs associated with overtime divided by the number of employees. This KPI can be used to help evaluate and predict shifts in workforce flexibility within an organization and can be used in compliance with workforce benefits regulations.

The foregoing description of preferred and other embodiments is not intended to limit or restrict the scope or applicability of the inventive concepts conceived of by the Applicants. In exchange for disclosing the inventive concepts contained herein, the Applicants desire all patent rights afforded by the appended claims. Therefore, it is intended that the appended claims include all modifications and alterations to the full extent that they come within the scope of the following claims or equivalents thereof.

What is claimed is:

1. A system for human capital management, comprising:
a digital storage medium;
an electronic device effective to receive input from a user and having a display;
a plurality of employee records encoded on the storage medium, each one employee record being associated with an individual employee and containing a value for at least one human capital metric associated with the individual employee;
said electronic device effective to access the plurality of employee records on the storage medium and present on the display a dashboard management window; and
said dashboard management window having at least one dashboard window, each dashboard window containing at least one automatically-generated representation of the human capital metric values of a plurality of employee records.

2. The system of claim 1 wherein a custom dashboard window can be created by the user.

3. The system of claim 1 wherein said automatically-generated representation is a comparison of at least one human capital metric value from the record of a particular employee to the human capital metric values from a select plurality of employee records.

4. The system of claim 1 wherein said automatically-generated representation regards a key performance indicator metric.

5. The system of claim 4 wherein said key performance indicator metric is selected from the group consisting of employee headcount, temporary employee percentage, part-time percentage, inactive employee ratio, leave rate, average age, age groupings, generation ratio, average employee tenure, average position tenure, tenure range ratio, ethnicity ratio, gender ratio, average retirement age, retirement eligibility, projected retirement, total turnover, voluntary termination, involuntary termination, new hire termination, internal mobility, transfer rate, promotion rate, internal mobility as a percentage of hires, manager span of control, total earnings, earning code totals, earning code averages, total overtime cost and average overtime cost.

6. The system of claim 1, wherein:
said storage medium is remote from the electronic device; and
said electronic device accesses the storage medium through a network.

7. The system of claim 1 wherein said dashboard management window is presented on the display through a web browser.

8. The system of claim 1, further comprising:
said electronic device also effective to present on the display a slider bar; and
said slider bar containing a set of summary information derived from the human capital metric values of a plurality of employee records.

9. The system of claim 1 wherein said electronic device is effective to present on the display an enlarged view of a particular dashboard window when the electronic device receives input that the particular dashboard window has been selected.

10. The system of claim 9 wherein the enlarged view of the particular dashboard window contains an amount of additional information relevant to the automatically generated representation of the particular dashboard window.

11. The system of claim 1, wherein said human capital metrics are average salary, incentive pay, labor cost, total hours, absence-to-overtime ratio, and overtime percentage.

12. The system of claim 1 wherein said automatically-generated representation is a visualization of the human capital metric values of a plurality of employee records.

13. The system of claim 12 wherein said visualization is a chart, the type of which is selected from the group consisting of column, bar, line, pie, area, scatter, stock, surface, doughnut, bubble and radar.

14. The system of claim 1 wherein said dashboard management window is customizable.

15. The system of claim 1 wherein said electronic device is effective to generate an alert when a particular criteria is met within the set of records.

16. The system of claim 1 wherein said electronic device is a mobile electronic device.

17. A method of managing human capital, comprising:
providing a digital storage medium;
providing an electronic device effective to receive input from a user and having a display;
encoding at least one set of employee records on the storage medium, each employee record being associated with an individual employee and containing a value for at least one human capital metric;
accessing on the electronic device the set of employee records from the storage medium; and
presenting on the display a dashboard management window having at least one dashboard window, each dashboard window containing at least one automatically-generated representation of the human capital metric values of a plurality of employee records.

18. The method of claim 17, wherein:
said storage medium is remote from the electronic device; and
said storage medium is accessed on the electronic device through a network.

19. The method of claim 17 further comprising:
selecting a particular dashboard window; and
presenting on the display an enlarged view of the particular dashboard window.

20. The method of claim 17 further comprising:
generating an alert when a particular criteria is met within the set of records; and
presenting on the display a notice of the alert.
